(19) United States
(12) Patent Application Publication
(10) Pub. No.: US 2019/0238404 A1
(43) Pub. Date: Aug. 1, 2019

(54) METHOD AND APPARATUS FOR COORDINATED SCHEDULING OF NETWORK FUNCTION VIRTUALIZATION INFRASTRUCTURE MAINTENANCE

(71) Applicant: NOKIA SOLUTIONS AND NETWORKS OY, Espoo (FI)

(72) Inventors: Yi Zhi YAO, Beijing (CN); Anatoly ANDRIANOV, Schaumburg, IL (US); Gyula BODOG, Budapest (HU)

(21) Appl. No.: 16/300,506

(22) PCT Filed: May 10, 2016
(86) PCT No.: PCT/US16/31637

§ 371 Date: Nov. 9, 2018

(51) Int. Cl. H04L 12/24; G06F 9/455

(52) U.S. Cl. CPC H04L 41/0806; G06F 2009/45595; G06F 9/45558; H04L 41/5041

(57) ABSTRACT

Systems, methods, apparatuses, and computer program products for coordinated scheduling of network function virtualization infrastructure (NFVI) maintenance are provided. One method includes receiving, by a network function virtualization entity, a request for scheduled maintenance of a network function virtualization infrastructure (NFVI). The method may also include determining whether one or more resources required for the maintenance of the NFVI are reserved, and sending an approval or rejection of the request for maintenance based on the determination of whether the resources are reserved.

### BACKGROUND

### Field

Some embodiments may generally relate to network function virtualization (NFV) and virtualized network function (VNF) management. In particular, certain embodiments may relate to approaches (including methods, apparatuses and computer program products) for coordination scheduling of network function virtualization infrastructure maintenance.

### Description of the Related Art

Network functions virtualization (NFV) refers to a network architecture model that uses the technologies of information technology (IT) virtualization to virtualize entire classes of network node functions into building blocks that may connect, or chain together, to create communication services.

A virtualized network function (VNF) may be designed to consolidate and deliver the networking components necessary to support a full virtualized environment. A VNF may be comprised of one or more virtual machines running different software and processes, on top of standard high-volume servers, switches and storage, or even cloud computing infrastructure, instead of having custom hardware appliances for each network function. One example of a VNF may be a virtual session border controller deployed to protect a network without the typical cost and complexity of obtaining and installing physical units. Other examples include virtualized load balancers, firewalls, intrusion detection devices and WAN accelerators.

In an NFV environment, a VNF may take on the responsibility of handling specific network functions that run on one or more virtualized containers on top of Network Functions Virtualization Infrastructure (NFVI) or hardware networking infrastructure, such as routers, switches, etc. Individual virtualized network functions (VNFs) can be combined to form a so called Network Service to offer a full-scale networking communication service.

Virtual network functions (VNFs) came about as service providers attempted to accelerate deployment of new network services in order to advance their revenue and expansion plans. Since hardware-based devices limited their ability to achieve these goals, they looked to IT virtualization technologies and found that virtualized network functions helped accelerate service innovation and provisioning. As a result, several providers came together to create the Network Functions Virtualization industry specification (ETSI ISG NFV group) under the European Telecommunications Standards Institute (ETSI). ETSI ISG NFV has defined the basic requirements and architecture of network functions virtualization.

In NFV, virtualized network functions (VNF) are software implementations of network functions that can be deployed on a network function virtualization infrastructure (NFVI). NFVI is the totality of all hardware and software components that build the environment where VNFs are deployed and can span several locations.

Each VNF may be managed by a VNF manager (VNFM). A VNFM may, for example, determine specific resources needed by a certain VNF when a VNF is instantiated (i.e., built) or altered. The so-called NFV orchestrator (NFVO) is responsible for network service management. A network service is a composition of network functions and defined by its functional and behavioral specification.

The NFVO is an entity that has the overview of the available, actually used and reserved resources in a multi-VNF environment and is also responsible for decisions about resource allocation and placement. The NFVO's tasks include lifecycle management (including instantiation, scale-out/in, termination), performance management, and fault management of virtualized network services. Further, the actual responsibility on where VNFs or their components are placed in the NFVI is with the NFVO.

### SUMMARY

One embodiment is directed to a method, which may include receiving, by a network function virtualization entity, a request for scheduled maintenance of a network function virtualization infrastructure (NFVI). The method may further include determining whether one or more resources required for the maintenance of the NFVI are reserved, and sending an approval or rejection of the request for maintenance based on the determination of whether the resources are reserved.

Another embodiment is directed to an apparatus including at least one processor and at least one memory including computer program code. The at least one memory and computer program code may be configured, with the at least one processor, to cause the apparatus at least to receive a request for scheduled maintenance of a network function virtualization infrastructure (NFVI), determine whether one or more resources required for the maintenance of the NFVI are reserved, and send an approval or rejection of the request for maintenance based on the determination of whether the resources are reserved.

Another embodiment is directed to an apparatus, which may include receiving means for receiving a request for scheduled maintenance of a network function virtualization infrastructure (NFVI), determining means for determining whether one or more resources required for the maintenance of the NFVI are reserved, and sending means for sending an approval or rejection of the request for maintenance based on the determination of whether the resources are reserved. Another embodiment is directed to a method, which may include determining, by a network function virtualization entity, the allowed time window for the maintenance of a network function virtualization infrastructure (NFVI), and sending the allowed time window for the maintenance of the NFVI.

Another embodiment is directed to an apparatus including at least one processor and at least one memory including computer program code. The at least one memory and computer program code may be configured, with the at least one processor, to cause the apparatus at least to determine the allowed time window for the maintenance of a network function virtualization infrastructure (NFVI), and send the allowed time window for the maintenance of the NFVI.

Another embodiment is directed to an apparatus including determining means for determining an allowed time window for the maintenance of a network function virtualization infrastructure (NFVI), and sending the allowed time window for the maintenance of the NFVI. Another embodiment is directed to a method, which may include receiving, by a network function virtualization entity, the allowed time window for the maintenance of a network function virtualization infrastructure (NFVI), forwarding the allowed time window for the maintenance of the NFVI, and sending an approval of the request for maintenance based on the allowed time window for the maintenance of the NFVI.

Another embodiment is directed to an apparatus including at least one processor and at least one memory including computer program code. The at least one memory and computer program code may be configured, with the at least one processor, to cause the apparatus at least to receive the allowed time window for the maintenance of a network function virtualization infrastructure (NFVI), forward the allowed time window for the maintenance of the NFVI, and send an approval of the request for maintenance based on the allowed time window for the maintenance of the NFVI.

Another embodiment is directed to an apparatus, which may include receiving means for receiving an allowed time window for the maintenance of a network function virtualization infrastructure (NFVI), forwarding the allowed time window for the maintenance of the NFVI, and sending an approval of the request for maintenance based on the allowed time window for the maintenance of the NFVI.

### BRIEF DESCRIPTION OF THE DRAWINGS

For proper understanding of the invention, reference should be made to the accompanying drawings, wherein:

FIG. 1 illustrates a block diagram of a system depicting an example of a NFV management and organization (MANO) architecture framework with reference points;

FIG. 2 illustrates an example signaling flow diagram, according to an embodiment;

FIG. 3a illustrates a block diagram of an apparatus, according to one embodiment;

FIG. 3b illustrates a block diagram of an apparatus, according to another embodiment; and

FIG. 4 illustrates an example flow diagram of a method, according to one embodiment.

### DETAILED DESCRIPTION

It will be readily understood that the components of the invention, as generally described and illustrated in the figures herein, may be arranged and designed in a wide variety of different configurations. Thus, the following detailed description of embodiments of systems, methods, apparatuses, and computer program products for coordinated scheduling of NFVI maintenance, is not intended to limit the scope of the invention, but is merely representative of some selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments.

Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

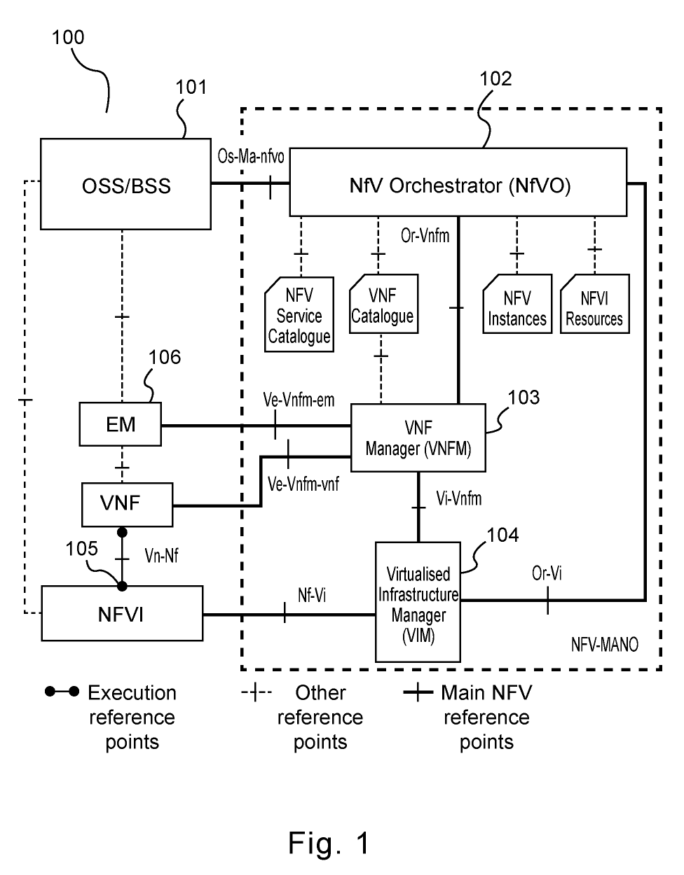

FIG. 1 illustrates a block diagram of a system 100 depicting an example of a NFV management and organization (MANO) architecture framework with reference points. The system 100 may include an operations support system (OSS) 101 which comprises one or more entities or systems used by network providers to operate their systems. A Network Manager (NM) is one typical entity/system which may be part of OSS. Further, in the architecture framework system 100 of FIG. 1, OSS/BSS 101 and NFVO 102 may be configured to manage the network service, while element manager (EM) 106 and VNFM 103 may be configured to manage VNF.

In a NFV environment, Network Function Virtualization Infrastructure (NFVI) 105 holds the hardware resources needed to run a VNF, while a VNF is designed to provide services. As an example, NFVO 102 may be responsible for on-boarding of new network services (NSs) and VNF packages, NS lifecycle management, global resource management, validation and authorization of NFVI resource requests. VNFM 103 may be responsible for overseeing the lifecycle management of VNF instances. Virtualized infrastructure manager (VIM) 104 may control and manage the NFVI compute, storage, and network resources.

NFVI 105 may be managed by the MANO domain exclusively, while VNF may be managed by both MANO and the traditional management system, such as the element manager (EM)/network manager (NM) 106. The virtualization aspects of a VNF are managed by MANO (NFVO 102, VNFM 103, and VIM 104), while the application of the VNF is managed by the element manager (EM)/network manager (NM) 106. A VNF is configured to provide services and these services can be managed by the element manager (EM)/network manager (NM) 106.

As mentioned above, NFVI 105 may be managed by MANO. This management of the NFVI 105 also includes maintenance activities. Based on 3GPP Technical Report 32.842 (“Study on Management of Virtualized Networks”), the NFVI maintenance (such as reset) may be scheduled by NFVO 102/VIM 104, and a notification may be sent to NM 106 for the scheduled maintenance.

Maintenance of NFVI may negatively impact services provided by the VNFs running on top of the NFVI. Thus, a notification about the scheduled maintenance is sent to NM. However, this is currently a one-way notification only, and the upcoming NFVI maintenance activity does not take into account the impact to service. Accordingly, the NFVI maintenance will just take place according to the schedule regardless of the impact to services.

However, embodiments of the invention recognize that it is important to schedule the NFVI maintenance activities that are aligned with the service providers' other maintenance activities to minimize the impact to the services that are provided by the VNFs running in the NFVI. Therefore, embodiments are configured to add a capability to the NM to confirm or control the NFVI maintenance schedule.

According to one embodiment of the invention, a network entity performing NFVI maintenance needs to receive acknowledgement or permission (e.g., from NM) before performing scheduled NFVI maintenance. In an embodiment, a request for NFVI maintenance may be sent from the NFVI to the VIM. The VIM may then check if resource(s) needed for the NFVI maintenance are reserved by other entities, such as the VNFM or NFVO. If the resource(s) are not used/not reserved, the VIM may approve the request for NFVI maintenance and perform the maintenance activities. If the resource(s) are being used or reserved, the VIM may request permission from the entity that reserved the resource(s).

According to one embodiment, the VIM may request permission by forwarding the NFVI maintenance request to the VNFM. The VNFM may then check if the resources are being used by any virtualized network function component(s) (VNFC(s)) of a VNF. If the resources are not used by any VNFC(s) of the VNF, the VNFM may approve the maintenance request to the VIM. If the resources are being used by any VNFC(s) of the VNF managed by the VNFM, the VNFM may determine the entities to request permission from (e.g., NFVO or EM or both) and requests the permission from the appropriate entity. The determination of entities to request the permission from may be based on a configuration parameter at VNFM level and/or a parameter in the VNFD.

In an embodiment, the VNFM may send the maintenance request to the EM. The maintenance request may include the affected VNF and/or VNFC(s), the NFVI PoPs that is planned for maintenance, the time and time zone of the maintenance window. Upon receiving the maintenance request, the EM may make a decision on its own for the maintenance window and can approve/reject the maintenance request. Alternatively, the EM may request permission for the maintenance activity from the OSS/NM.

In another embodiment, the maintenance request may be sent to the NFVO by the VNFM or VIM. According to this embodiment, the NFVO receives the maintenance request from the VNFM or from the VIM. If the request is received from the VNFM, then the resources are being used by at least one VNF (otherwise the VNFM would have approved the maintenance request on its own). The NFVO may check if the resources are used by any Network Service (NS) that is managed by the NFVO. If the resources are not used by any NS, the NFVO may approve the maintenance request to the VNFM (an example case could be when the VNF is instantiated from the EM). If the resources are used by a NS, the NFVO may request permission from the OSS/NM to approve the maintenance request. This request for permission from the OSS/NM may include the NFVO sending the maintenance request to the OSS/NM. The OSS/NM may then approve or reject the maintenance request. Alternatively, the OSS/NM may indicate that the request is pending for further notice, which means that the NFVO needs to wait for further guidance from the OSS/NM.

If the maintenance request is received by the NFVO from the VIM directly, the NFVO may check if the resource(s) are being used by any NS the NFVO manages. If none of the NSs are using the resource(s), the NFVO may approve the maintenance request and the VIM can perform the NFVI maintenance. If the resources are being used by a NS, the NFVO may need to check if NS instantiation is ongoing and not yet reported as completed to the OSS/NM. If the NS instantiation is not completed, NFVO can approve the maintenance request to the VIM and the VIM can perform the maintenance. If the NS instantiation is completed, the NFVO may need to request permission from the OSS/NM for the maintenance request. The OSS/NM may approve or reject the maintenance request. Alternatively, if the OSS/NM indicates that the request is pending for further notice, the NFVO may need to wait for further guidance from the OSS/NM.

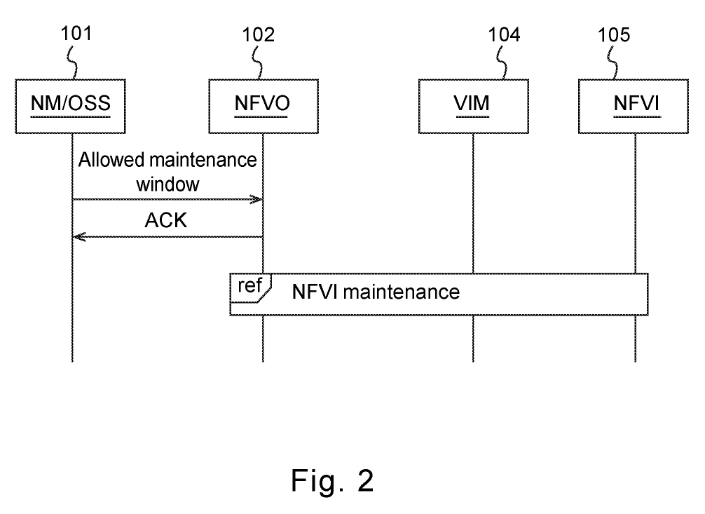

In another embodiment of the invention, the OSS/NM may send the already known and allowed maintenance windows to the NFVO. FIG. 2 illustrates a signaling flow diagram, according to this embodiment of the invention. As illustrated in FIG. 2, at 200, the OSS/NM may send a message including the allowed maintenance window to the NFVO. This message may include the identification of the NFVI PoP that requires maintenance, and the time window of the maintenance with time zone information. In order to ensure that the maintenance activities are synchronised correctly, the time of OSS/NM and NFVO may be synchronised and, for this purpose, the NTP protocol may be used. As also illustrated in FIG. 2, at 210, the NFVO may send an acknowledgement to the OSS/NM. According to one embodiment, the maintenance window may be forwarded to the VIM and the VNFM. In an embodiment, the NFVO may allow the VIM to perform maintenance, at 220, on resource(s) that are not part of any VNF. In addition, the NFVO may allow the VNFM to perform maintenance on VNFC(s) and any resource(s) that are used by those. In one embodiment, the VNFM may allow the VIM to perform maintenance on the resource(s) that are used by VNFC(s).

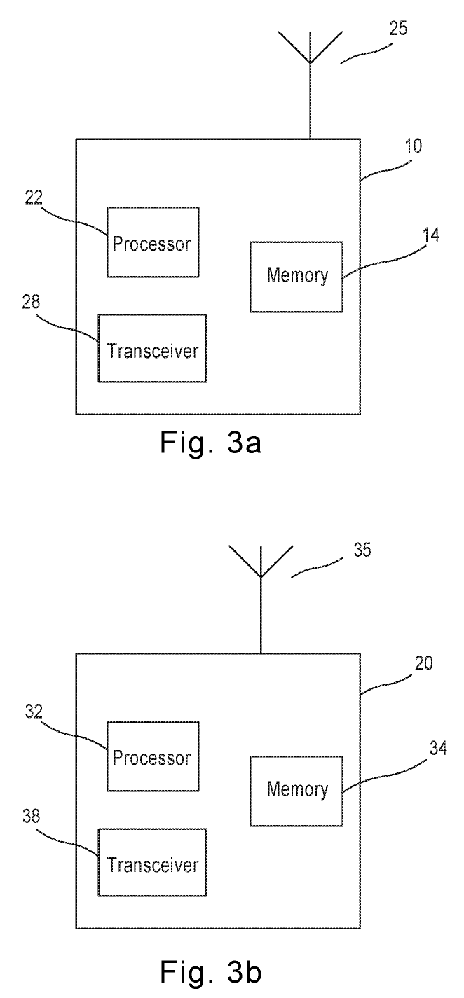

FIG. 3a illustrates an example of an apparatus 10 according to an embodiment. In an embodiment, apparatus 10 may be a node, host, or server in a communications network or serving such a network. In an embodiment, apparatus 10 may be a virtualized apparatus. For example, in certain embodiments, apparatus 10 may be one or more of an operations support system, a network manager (e.g., a network manager within an operations support system), a network function virtualization orchestrator, and/or a virtualized network function manager, as shown in FIG. 1. However, in other embodiments, apparatus 10 may be other components within a radio access network or other network infrastructure. It should be noted that one of ordinary skill in the art would understand that apparatus 10 may include components or features not shown in FIG. 3a.

As illustrated in FIG. 3a, apparatus 10 may include a processor 22 for processing information and executing instructions or operations. Processor 22 may be any type of general or specific purpose processor. While a single processor 22 is shown in FIG. 3a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. It should be noted that, in certain embodiments, apparatus 10 may be a virtualized apparatus and processor 22 may be a virtual compute resource.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein. In other embodiments, memory 14 may be part of virtualized compute resource or virtualized storage resource.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly. In some embodiments, transceiver 28 may be comprised of virtualized network resources.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources. As mentioned above, in certain embodiments, processor 22 may be a virtualized compute resource that is capable of performing functions associated with virtualized network resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

In certain embodiments, apparatus 10 may be or may act as an operations support system (OSS/NM), a network manager (NM), a network function virtualization orchestrator (NFVO), a virtualized infrastructure manager (VIM), and/or a virtualized network function manager (VNFM), for example. According to certain embodiments, a network function may be decomposed into smaller blocks or parts of application, platform, and resources. The network function may be at least one of a physical network function or a virtualized network function.

According to one embodiment, apparatus 10 may be or may act as a VNFM, such as VNFM 103, or a VIM, such as VIM 104, as illustrated in FIG. 1 discussed above. In an embodiment, apparatus 10 may be controlled by memory 14 and processor 22 to receive a request for scheduled maintenance of a network function virtualization infrastructure (NFVI), to determine whether one or more resources required for the maintenance of the NFVI are reserved, and to send an approval or rejection of the request for maintenance based on the determination of whether the resources are reserved.

In an embodiment, apparatus 10 may be controlled by memory 14 and processor 22 to send the approval of the request for maintenance when it is determined that the resources are not reserved. When it is determined that the resources are reserved, apparatus 10 may be controlled by memory 14 and processor 22 to request permission from the entity that reserved the resources to use the resources for the maintenance.

According to one embodiment, apparatus 10 may be controlled by memory 14 and processor 22 to determine whether the resources are reserved by checking if the resources are used by any virtualized network function container(s) (VNFC(s)) of a virtualized network function (VNF). When the resources are not used by any VNFC(s) of the VNF, apparatus 10 may be controlled by memory 14 and processor 22 to approve the request for maintenance When the resources are being used by the VNFC(s) of the VNF, apparatus 10 may be controlled by memory 14 and processor 22 to determine at least one entity to request permission from and requesting the permission from the at least one entity. The determining of the at least one entity to request permission from may be based on configuration parameters at VNF manager (VNFM) level and/or a parameter in VNF descriptor (VNFD).

In one embodiment, apparatus 10 may be controlled by memory 14 and processor 22 to determine whether the resources are reserved by forwarding the request for the scheduled maintenance to an element manager (EM). The EM may approve or rejects the request itself, or the EM may request permission for the maintenance from an operations support system (OSS/NM).

According to an embodiment, the request for the scheduled maintenance may include the affected VNF and/or VNFC(s), NFVI points of presence (PoPs) that are planned for maintenance, time and/or time zone of maintenance window.

In one embodiment, apparatus 10 may be or may act as a network function virtualization orchestrator (NFVO). In this embodiment, apparatus 10 may be controlled by memory 14 and processor 22 to determine whether the resources are reserved by determining whether the resources are being used by any network services (NSs) that are managed by the NFVO. When the resources are not being used by any of the NSs that are managed by the NFVO, apparatus 10 may be controlled by memory 14 and processor 22 to approve the request for maintenance of the NFVI. When the resources are being used by one of the NSs, apparatus 10 may be controlled by memory 14 and processor 22 to request permission from an operations support system (OSS/NM) to approve the request for maintenance of the NFVI.

When the resources are being used by one of the NSs, apparatus 10 may be controlled by memory 14 and processor 22 to determine whether NS instantiation is ongoing and not yet reported as completed to operations support system (OSS/NM). When the NS instantiation is not completed, apparatus 10 may be controlled by memory 14 and processor 22 to approve the request for maintenance of the NFVI. When the NS instantiation is completed, apparatus 10 may be controlled by memory 14 and processor 22 to request permission from an operations support system (OSS/NM) to approve the request for maintenance of the NFVI.

FIG. 3b illustrates an example of an apparatus 20 according to another embodiment. In an embodiment, apparatus 20 may be a node, element, or entity in a communications network or associated with such a network. In an embodiment, apparatus 20 may be a virtualized apparatus. For example, in certain embodiments, apparatus 20 may be an operations support system, network manager (e.g., a network manager within an operations support system) network function virtualization orchestrator, and/or virtualized network function manager, as shown in FIG. 1. However, in other embodiments, apparatus 20 may be other components within a radio access network or other network infrastructure. It should be noted that one of ordinary skill in the art would understand that apparatus 20 may include components or features not explicitly shown in FIG. 3b.

As illustrated in FIG. 3b, apparatus 20 includes a processor 32 for processing information and executing instructions or operations. Processor 32 may be any type of general or specific purpose processor. While a single processor 32 is shown in FIG. 3b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. It should be noted that, in certain embodiments, apparatus 20 may be a virtualized apparatus and processor 32 may be a virtual compute resource.

Apparatus 20 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein. In other embodiments, memory 34 may be part of virtualized compute resource or virtualized storage resource.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly. In some embodiments, transceiver 38 may be comprised of virtualized network resources.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources. As mentioned above, in certain embodiments, processor 32 may be a virtualized compute resource that is capable of performing functions associated with virtualized network resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

According to one embodiment, apparatus 20 may be or may act as a network function virtualization orchestrator (NFVO), such as NFVO 102 illustrated in FIG. 1. According to an embodiment, apparatus 20 may be controlled by memory 34 and processor 32 to receive a message including the allowed maintenance window for NFVI from the OSS/NM. This message may include the identification of the NFVI PoP that requires maintenance, and/or the time window of the maintenance with time zone information. In order to ensure that the maintenance activities are synchronised correctly, the time of OSS/NM and apparatus 20 may be synchronised and, for this purpose, the NTP protocol may be used. In an embodiment, apparatus 20 may be controlled by memory 34 and processor 32 to send an acknowledgement to the OSS/NM. According to one embodiment, apparatus 20 may be controlled by memory 34 and processor 32 to forward the maintenance window to the VIM and/or the VNFM. In an embodiment, apparatus 20 may be controlled by memory 34 and processor 32 to allow the VIM to perform the maintenance on resource(s) that are not part of any VNF. In addition, apparatus 20 may be controlled by memory 34 and processor 32 to allow the VNFM to perform maintenance on VNFC(s) and any resource(s) that are used by those VNFC(s). In one embodiment, apparatus 20 may be controlled by memory 34 and processor 32 to allow the VIM to perform maintenance on the resource(s) that are used by VNFC(s).

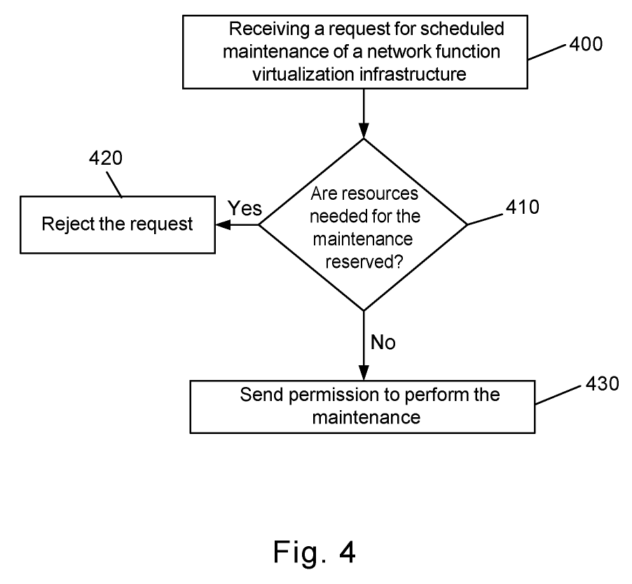

FIG. 4 illustrates an example flow diagram of a method, according to one embodiment. The method of FIG. 4 may be performed by any of the nodes or entities of a virtualized network environment, such as the one illustrated in FIG. 1. For example, the method of FIG. 4 may be performed by a VIM, VNFM, and/or NFVO, for example. The method may include, at 400, receiving a request for scheduled maintenance of a network function virtualization infrastructure (NFVI). The method may then include, at 410, determining whether one or more resources required for the maintenance of the NFVI are reserved. If it is determined that the resources are not reserved, the method may include, at 430, sending an approval of the request for maintenance The maintenance may then be performed by the VIM, for example. If it is determined that the resources are reserved, the method may include, at 420, sending a rejection of the request for maintenance.

In an embodiment, when it is determined that the resources are reserved and prior to sending the rejection, the method may include requesting permission from the entity that reserved the resources to use the resources for the maintenance According to one embodiment, the determining step may further include checking if the resources are used by any virtualized network function component(s) (VNFC(s)) of a virtualized network function (VNF). When the resources are not used by any VNFC(s) of the VNF, the method may include approving the request for maintenance When the resources are being used by the VNFC(s) of the VNF, the method may further include determining at least one entity to request permission from and requesting the permission from the at least one entity. The determining of the at least one entity to request permission from may be based on configuration parameters at VNF manager (VNFM) level and/or a parameter in VNF descriptor (VNFD).

According to one embodiment, the determining step may further include forwarding the request for the scheduled maintenance to an element manager (EM), which approves or rejects the request itself or requests permission for the maintenance from an OSS/NM. In certain embodiments, the request may include an affected VNF and/or VNFC(s), NFVI points of presence (PoPs) that are planned for maintenance, time and/or time zone of maintenance window.

According to one embodiment, when the method of FIG. 4 is performed by a network function virtualization orchestrator (NFVO), the determining step may further include determining whether the resources are being used by any network services (NSs) that are managed by the NFVO. When the resources are not being used by any of the NSs that are managed by the NFVO, the method may further include approving the request for maintenance of the NFVI. When the resources are being used by one of the NSs, the method may further include requesting permission from an OSS/NM to approve the request for maintenance of the NFVI.

In an embodiment, when the resources are being used by one of the NSs, the method may further include determining whether NS instantiation is ongoing and not yet reported as completed to OSS/NM. When the NS instantiation is not completed, the method may further include approving the request for maintenance of the NFVI. When the NS instantiation is completed, the method may further include requesting permission from an OSS/NM to approve the request for maintenance of the NFVI.

In view of the above, embodiments of the invention are able to achieve several advantages and/or technical improvements. For example, these advantages and/or technical improvements include scheduling NFVI maintenance in a manner that is aligned with other maintenance activities and to minimize the impact to the services that are provided by the VNFs running in the NFVI. As a result, embodiments result in more efficient network services, which may include technical improvements such as reduced overhead and increased speed.

In some embodiments, the functionality of any of the methods, processes, or flow charts described herein may be implemented by software and/or computer program code or portions of code stored in memory or other computer readable or tangible media, and executed by a processor. In some embodiments, the apparatus may be, included or be associated with at least one software application, module, unit or entity configured as arithmetic operation(s), or as a program or portions of it (including an added or updated software routine), executed by at least one operation processor. Programs, also called program products or computer programs, including software routines, objects, functions, applets and/or macros, may be stored in any apparatus-readable data storage medium and may include program instructions to perform particular tasks.

A computer program product may comprise one or more computer-executable components which, when the program is run, are configured to carry out embodiments of the invention. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of code may be in a source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, or software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, or a non-tangible means, that can be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method, comprising:
receiving, by a network function virtualization entity, a request for scheduled maintenance of a network function virtualization infrastructure (NFVI);
determining whether one or more resources required for the maintenance of the NFVI are reserved; and
sending an approval or rejection of the request for maintenance based on the determination of whether the resources are reserved.

2-5. (canceled)

6. The method according to claim 1, wherein, determining at least one entity to request permission from and requesting the permission from the at least one entity.

7. The method according to claim 6, wherein the determining of the at least one entity to request permission from is based on configuration parameters at management entity level.

8. The method according to claim 6, wherein the determining of the at least one entity to request permission from is based on a parameter at managed entity level.

9. The method according to claim 1, wherein the determining further comprises forwarding the request for the scheduled maintenance to an element manager (EM), wherein the EM approves or rejects the request itself or wherein the EM requests permission for the maintenance from an OSS/NM.

10. The method according to claim 1, wherein the determining further comprises forwarding the request to a network function virtualization orchestrator (NFVO).

11. The method according to claim 1, wherein the request comprises at least one of an affected VNF and/or VNFC(s), NFVI points of presence (PoPs) that are planned for maintenance, time and time zone of maintenance window.

12. The method according to claim 1, wherein the network function virtualization entity comprises a virtualized infrastructure manager (VIM) or a virtualized network function manager (VNFM).

13. The method according to claim 1,
wherein the network function virtualization entity comprises a network function virtualization orchestrator (NFVO),
wherein the determining further comprises determining whether the resources are being used by any network services (NSs) that are managed by the NFVO,
the method further comprising, when the resources are not being used by any of the NSs that are managed by the NFVO, approving the request for maintenance of the NFVI.

14. The method according to claim 13, further comprising, when the resources are being used by one of the NSs, requesting permission from an OSS/NM to approve the request for maintenance of the NFVI.

15. The method according to claim 12, wherein, when the resources are being used by one of the NSs, the method further comprises:
determining whether NS instantiation is ongoing and not yet reported as completed to OSS/NM;
when the NS instantiation is not completed, approving the request for maintenance of the NFVI; and
when the NS instantiation is completed, requesting permission from an OSS/NM to approve the request for maintenance of the NFVI.

16. A method, comprising:
determining, by a network function virtualization entity, an allowed time window for maintenance of a network function virtualization infrastructure (NFVI); and
sending the allowed time window for the maintenance of the NFVI.

17. The method according to claim 16, wherein the network function virtualization entity is OSS/NM.

18. A method, comprising:
receiving, by a network function virtualization entity, an allowed time window for maintenance of a network function virtualization infrastructure (NFVI);
forwarding the allowed time window for the maintenance of the NFVI; and
sending an approval of the request for maintenance based on the allowed time window for the maintenance of the NFVI.

19. The method according to claim 18, wherein the network function virtualization entity comprises a NFVO, or a VNFM or a VIM.

20. An apparatus, comprising:
at least one processor; and
at least one memory including computer program code,
wherein the at least one memory and computer program code are configured, with the at least one processor, to cause the apparatus at least to
receive a request for scheduled maintenance of a network function virtualization infrastructure (NFVI);
determine whether one or more resources required for the maintenance of the NFVI are reserved; and
send an approval or rejection of the request for maintenance based on the determination of whether the resources are reserved.

21-25. (canceled)

26. The apparatus according to claim 20, wherein the apparatus is further caused to determine at least one entity to request permission from and to request the permission from the at least one entity.

27. The apparatus according to claim 26, wherein the at least one entity to request permission from is determined based on configuration parameters at management entity level.

28. The apparatus according to claim 26, wherein the at least one entity to request permission from is determined based on a parameter at managed entity level.

29. The apparatus according to claim 20, wherein the apparatus is further caused to forward the request for the scheduled maintenance to an element manager (EM), wherein the EM approves or rejects the request itself or wherein the EM requests permission for the maintenance from an OSS/NM.

30. The apparatus according to claim 20, wherein the apparatus is further caused to forward the request to a network function virtualization orchestrator (NFVO).

31. The apparatus according to claim 20, wherein the request comprises at least one of an affected VNF or VNFC(s), NFVI points of presence (PoPs) that are planned for maintenance, time and time zone of maintenance window.

32. The apparatus according to claim 20, wherein apparatus comprises a virtualized infrastructure manager (VIM) or a virtualized network function manager (VNFM).

33. The apparatus according to claim 20,
wherein the apparatus comprises a network function virtualization orchestrator (NFVO),
wherein the apparatus is further caused to determine whether the resources are being used by any network services (NSs) that are managed by the NFVO, and
when the resources are not being used by any of the NSs that are managed by the NFVO, to approve the request for maintenance of the NFVI.

34. The apparatus according to claim 33, wherein, when the resources are being used by one of the NSs, permission is requested from an OSS/NM to approve the request for maintenance of the NFVI.

35. The apparatus according to claim 33, wherein, when the resources are being used by one of the NSs, the apparatus is further caused to:
determine whether NS instantiation is ongoing and not yet reported as completed to OSS/NM;
when the NS instantiation is not completed, approve the request for maintenance of the NFVI;
when the NS instantiation is completed, request permission from OSS/NM to approve the request for maintenance of the NFVI.

36-39. (canceled)

40. A computer program embodied on a non-transitory computer readable medium, the computer program configured to control a processor to perform the method according to claim 1.
